(19) United States
(12) Patent Application Publication
(10) Pub. No.: US 2025/0292188 A1
(43) Pub. Date: Sep. 18, 2025

(54) OPTIMIZED LAYOUT GENERATOR USING CLIENT VIRTUALIZATION AND OPTIMIZATION TECHNIQUES

(71) Applicant: Dell Products L.P., Round Rock, TX (US)

(72) Inventors: Marcus Vinicius Libardi Pazini, Caxias do Sul (BR); Alisson Linhares de Carvalho, Campinas (BR); Herberth Birck Fröhlich, Florianópolis (BR)

(21) Appl. No.: 18/605,646

(22) Filed: Mar. 14, 2024

(51) Int. Cl. G06Q 10/067; G06Q 10/04

(52) U.S. Cl. CPC G06Q 10/067; G06Q 10/04

(57) ABSTRACT

One example method includes constructing a population space of customers, constructing an objective function of interest concerning the customers and a store, using an optimization algorithm to find, based on the objective function of interest, a store layout that maximizes one or more metrics relating to the customers and products of the store, and generating an optimized layout for the store based on an outcome of the optimization algorithm, and the optimized layout satisfies the objective function of interest and is based on buying preferences of the customers.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### FIELD OF THE INVENTION

Embodiments of the present invention generally relate to optimization of physical layouts. More particularly, at least some embodiments of the invention relate to systems, hardware, software, computer-readable media, and methods, for optimizing a layout of a store in which customers may purchase products.

### BACKGROUND

The positioning of items is a key aspect of many types of business and industries, as an example, there is many amounts of research in customer behavior for learning patterns to define the positioning of products in retail stores with the goal of encouraging customers to spend more time walking down aisles and being exposed to more merchandise.

To solve this problem, one conventional approach is to use datamining techniques in a wide corpus of data such as CCTV footage for customer trajectories, camera footage from shelves to produce heatmaps related to where customers look at or pick products and linking each person with the items that were bought for buyer behavior mapping. Once data is collected, a human is responsible for finding the best possible layout by using techniques such as correlations for figuring out changes in current product placement for increasing sales or client permanence in store. While this type of technique is being used in industry and produces satisfactory results, there are drawbacks and, consequently, room for improvement exists.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses a hypothetical arrangement of pedestrians in a physical environment.

FIG. 2 discloses aspects of a customer service vector k according to one example embodiment.

FIG. 3 discloses a hypothetical example of a simplified store layout and the progression of customer interests for three steps.

FIG. 4 discloses a hypothetical example of how customer interests are incorporated in a Social Force Model.

FIG. 5 discloses an optimization cycle according to one embodiment.

FIG. 6 discloses behavior of an exponential function displaced by t, according to one embodiment.

FIG. 7 discloses a hypothetical set of possible different store layout that may be used for algorithm initialization.

FIG. 8 discloses an optimization cycle applied to one particular example, according to an embodiment.

FIG. 9 discloses an example computing entity configured and operable to perform any of the disclosed methods, processes, and operations.

### DETAILED DESCRIPTION OF SOME EXAMPLE EMBODIMENTS

Embodiments of the present invention generally relate to optimization of physical layouts. More particularly, at least some embodiments of the invention relate to systems, hardware, software, computer-readable media, and methods, for optimizing a layout of a store in which customers may purchase products.

One example embodiment comprises a method that may be used to generate an optimized layout for an environment in which humans are present and move. One example of such a method may comprise the operations: constructing a population space of clients w from historical data; constructing a function of interest that maps explicitly the interest of a client in moving forward in aisles and continuing shopping; using an optimization algorithm to find a layout that maximizes the time spent in store, distance traveled, aisles visited or other user-defined metrics; and, providing an optimized layout for the store based on the buying preferences of the clients.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that an optimized physical layout for a space may be defined without requiring human involvement to determine the optimized physical layout. An embodiment may define an optimized physical layout in a way that avoids problems that would be caused by human involvement in the optimization process. An embodiment may generate an optimized physical layout for a space more quickly and accurately than a human would be able to do. Various other advantages of one or more example embodiments will be apparent from this disclosure.

### A. Context for an Example Embodiment

The following is a discussion of aspects of a context for various embodiments of the invention. This discussion is not intended to limit the scope of the invention, or the applicability of the embodiments, in any way.

In this section, a discussion is provided of one methodology for simulation of human motion in enclosed environments, that is, the Social Force Model (SFM). This technique is further employed to allow the agents, that is, the humans in the environment, to behave as naturally as possible and according to their interests within a constrained environment. While the SFM technique is one choice for modelling customer walking behavior, other techniques that can provide comparable results may alternatively be used, such as “A. Gupta, J. Jhonson, L. Fei-Fei, S. Savarese e A. Alahi, “Social GAN: Socially Acceptable Trajectories with Generative Adversarial Networks,” IEEE/CVF Conference on Computer Vision and Pattern Recognition, pp. 2255-2264, 2018” and “A. Sadeghian, V. Kosaraju, N. Hirose e S. Savarese, “Sophie: An Attentive GAN for Predicting Paths Compliant to Social and Physical Constraints,” IEEE/CVF Conference on Computer Vision and Pattern Recognition (CVPR), pp. 1349-1358, 2018,” both of which are incorporated herein in their respective entireties by this reference.

In an SFM, model behavior changes as social forces, which may be thought of as forces that may act upon the pedestrians and guide their motion in space. The following equation represents every force that might act upon individuals and the interaction of the agents with the force field that will affect the path of motion:

$${f}_{i} ( t ) = {m}_{i} \frac{{dv}_{i}}{dt} = {m}_{i} {a}_{i} ( t ) = {\sum }_{j \neq i} {f}_{ij} ( t ) + {\sum }_{w} {f}_{iw} ( t ) + {\sum }_{a} {f}_{ia} ( t ) + {ξ}_{i} ( t )$$

where fᵢ denotes the sum of all forces acting in the pedestrian i and the result of this summation divided by the pedestrian's mass will result in the acceleration vector aᵢ that governs the agent's motion.

Each term in the equation represents a specific characteristic regarding the interactions of the individual with the environment. The first term of the sum represents the repelling forces of all other pedestrians with respect to the i-th pedestrian, the second term relates to the force exerted by objects such as walls, stairs, and boxes, the third term regards the attraction/repulsion of pedestrian to environment agents, such as shop windows, large screens, and other features of the environment, and the last term is a noise term. One simplification is setting mᵢ=m=1, ∀i—in this way, all the forces can be considered as acceleration.

The last step is to define the functions that model the intensity of the forces, for example, using a potential function such as:

$${U}_{ij} = {m}_{i} {A}_{i} \cdot exp ( - \frac{‖ {r}_{ij} ( t ) ‖}{{B}_{i}} )$$

In this equation, the r term denotes the position of the i-th pedestrian w.r.t the j-th pedestrian and the parameters Aᵢ and Bᵢ denote the intensity and interaction distances. Calculating the gradient of the potential function yields the force field, thus:

$${f}_{ij} = - {∇}_{{r}_{ij}} {U}_{ij} ( {r}_{ij} ( t ) , t ) = {D}_{i} \cdot exp ( - \frac{‖ {r}_{ij} ( t ) ‖}{{B}_{i}} ) \frac{{r}_{ij} ( t )}{‖ {r}_{ij} ( t ) ‖}$$

Where Dᵢ=Aᵢ/Bᵢ and the interactions between pedestrians and different elements in the simulation can be regulated by changing the parameter Dᵢ.

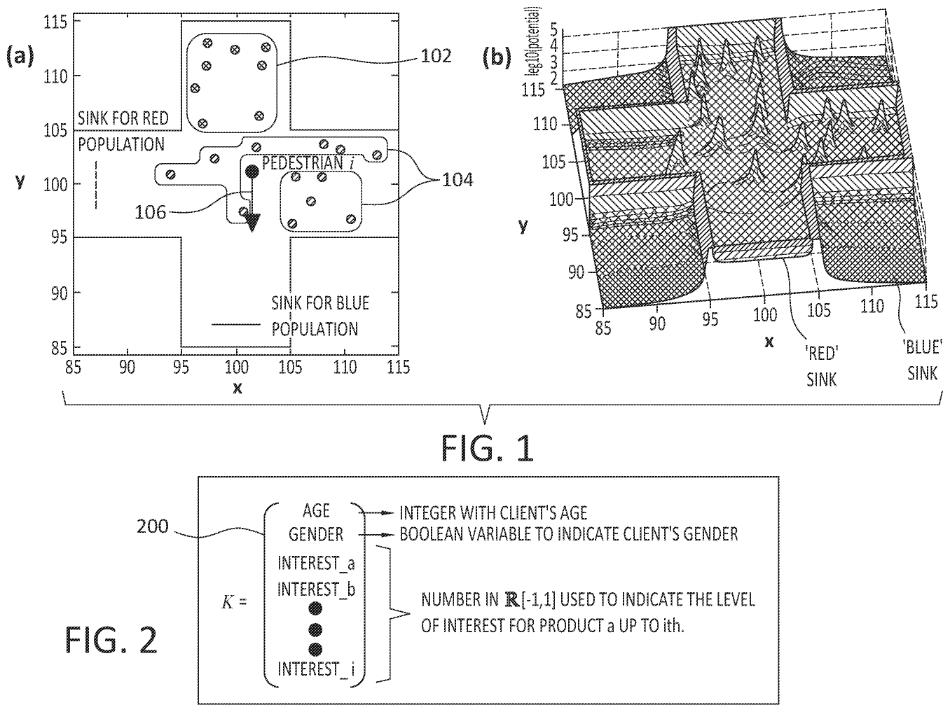

FIG. 1(a) shows the position of pedestrians in a crossing in which the pedestrians 102 move towards the ‘sink for blue population,’ and the pedestrians 104 move towards the ‘sink for red population.’ FIG. 1(b) shows the potential fields as seen by the i-th pedestrian 106 travelling to the region marked in blue.

Once all the equations are formulated and fᵢ is calculated for the t-ih step, the pedestrian state may be updated by calculating its next position in the domain.

$${v}_{i} ( t + Δ t ) = {v}_{i} ( t ) + \frac{{f}_{i}}{{m}_{i}} ( t ) Δ t , {r}_{i} ( t + Δ t ) = {r}_{i} ( t ) + {v}_{i} ( t ) Δ t$$

### B. Overview of Aspects of an Example Embodiment

### B.1 Introduction

An example embodiment may be effective in solving one or more of the shortcomings noted herein with regard to conventional approaches to layout optimization. Thus, for example, an embodiment may: (1) produce an optimized layout for the first iteration of the store, without the necessity of opening and testing empirically; (2) drop the “human in the loop” aspect of conventional methods; and, (3) use an optimization method, instead of analytics, to define an optimized store layout—this approach may cut out a human-introduced empirical aspect such as is present in conventional methods, and avoid introducing the bias of human specialists, while also providing a solution which is proven to be the best scenario.

### B.2 Overview

An example embodiment may solve the three aspects noted immediately above. To do this, an embodiment may, as a first step or process, define and develop a population space 22, where each element of this population stands for one possible client that could potentially enter the store. This population space may be obtained with market research, which is a practice commonly employed in the business world and as such may not require significant resources to perform. Each element ω∈Ω is defined as a vector of features describing the shopping behavior and interests of the client. As an example, this feature vector may indicate if the sampled client has interests in products such as electronics, clothes, or tools.

In an embodiment, the next process may comprise transforming the feature vector in a “virtual client” (κ), that is, not only will this feature vector will represent a possible client from the population space, but the feature vector will also receive, or otherwise be associated with, an attribute that will allow the feature vector to interact with a digital model of a store to make decisions such as move forward, change aisles, or exit the store. This property may be embedded into k with a function of interest ϕ, that will increase as the client reaches his purchase goal or passes through aisles that contain products that are compatible with the feature vector of that client. Also, whenever the client moves through aisles that have products too distinct from their features, the function of interest goes low. At any time when the function of interest of a client reaches a lower bound, the client leaves the store and the time spent shopping may be computed. Whenever the client reaches the product that he/she has most affinity with, he/she buys and leaves the store. Again, when this happens, the time spent in the store may be quantified.

With the development of a good modelling of K, which may be dependent upon good market research and an adequate choice of ϕ, an embodiment may use optimization algorithms such as Genetic Algorithm (GA) to find among a population of store layouts (Λ) that will receive a population of virtual clients sampled from Ω which is the best layout (λ*) in satisfying the objective function of the problem. An example of an objective function, in one embodiment, may be a time range that clients stay in a store. In another embodiment however, multi objective functions may be employed, such as incorporating the maximum distanced traveled by the client without repeating aisles.

As explained above then, an embodiment may employ historical purchase data and market research to find the best store layout, given a predefined objective function. One embodiment may comprise the following operations:
1. constructing a population space of clients w from historical data;
2. constructing a function of interest that maps explicitly the interest of a client in moving forward in aisles and continuing shopping;
3. using an optimization algorithm to find a layout that maximizes the time spent in store, distance traveled, aisles visited or other user-defined metrics; and
4. providing an optimized layout for the store based on the buying preferences of the clients of the store.

Thus, an embodiment may use a function of interest to support a feature vector that represents a client and the ability of the client to interact with a virtual layout. As well, an embodiment, may use an optimization algorithms to find layouts based on clients and store properties, without requiring the presence or participation of a human in the optimization loop.

In contrast with an embodiment, there are presently no known approaches that offer the capability for businesses to optimize their physical store layouts before building their installations, and without the disadvantages of having a human in the loop that can induce bias in their analysis or change the layout in a much more empirical way rather than with mathematical modeling/reasoning.

### C. Detailed Discussion of Aspects of an Example Embodiment

One embodiment may assumes prior knowledge of client preferences to develop the necessary constructs that allows the method to perform. In an embodiment then, the outcome of the method may be linked to the data quality regarding customers and how well an estimation of the population 22 may be constructed. The present section details how an embodiment may be used to perform a layout optimization once a suitable dataset has been collected.

### C.1 Setting Up the Environment, and Client Interactions

Before running any optimization routine, a simulation environment, and a virtual representation of a customer to interact with it, may be constructed. In an embodiment, this process may include setting up the following elements:
Store environment: A virtual representation of the store, this representation has the dimensions of the real asset and all its components, such as aisles, product shelves, corridors or any other asset that can influence the movement of customers.
Virtual customer: The virtual customer individual element is defined as κ, and in a store environment, n numbers of customers may exist that together form the set K={κ₁, κ₂, . . . , κₙ}. Each of elements K may comprise a vector that states preferences and particularities for a specific customer, real or virtual. An example of construction of a customer vector is identified at 200 in FIG. 2. One of more of the variables in the vector 200 may be Boolean to indicate categorical features such as gender, or also number in arbitrary scales to indicate relative levels of interest, for example, a value of 9, out of 10, for ‘Interest_a’ may indicate the customer has a high level of interest in home improvement tools. The vector 200 is presented only for the purposes of illustration and, more generally, a vector may have any type and number of elements that may relate in some way to optimization of a space in which a customer, with which the vector is associated, may be expected to be present and move.

It is important to highlight that, in an embodiment, the virtual customer is a dynamic entity. In this framework, that term means that, as in the real-world, a virtual customer can change their preferences from a time instant t to t+1. An example of this is when the customer moves through the store and finds a product of interest. If this product is purchased, the customer loses interest for this specific item in this particular shopping journey and, thus, the interest for each product may be updated in every time step of the simulation.

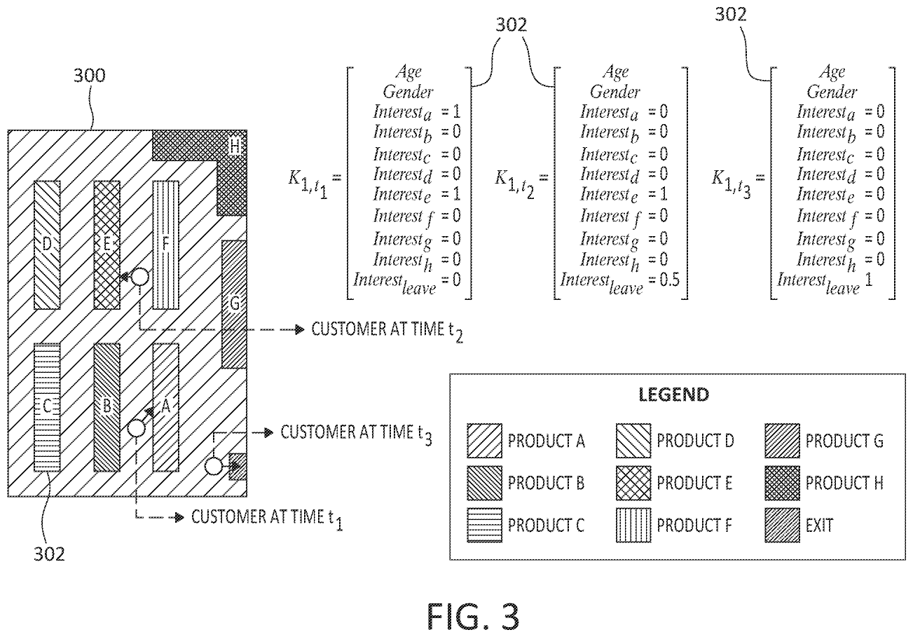

FIG. 3 discloses this phenomenon in the context of a simplified representation of a store 300 that includes some shelves and associated products. Within this store 300, a customer may be tracked during three steps and his/her interests may be updated at each of these steps. In particular, it can be seen that the vector 302 is updated at each of three different times t₁, t₂, and t₃. In an embodiment, the vector 302, corresponding to customer κ₁, may comprise binary elements indicating an element of the vector 302 is met (value=1), or the element is not met (value=0). For example, at time t₁, the elements ‘Interestₒ’ and ‘interestₑ’ are 1, and all the other elements are 0, except for the element ‘Interest leave’ which is 0. At time t₂, after the customer has interacted in some way with Product A, the ‘Interest,’ has correspondingly changed to 0, and ‘Interestₗₑₐᵥₑ’ is 0.5, indicating a greater likelihood that the customer will leave the store 300, and the other elements are all 0. Finally, at time t₃, all the elements are 0, except for the element ‘Interestₗₑₐᵥₑ’ which is 1, indicating that the customer will leave the store 300. In an embodiment, once the two elements, that is, the dynamic entity and the shopping journey, are constructed, the only remaining aspect for obtaining a complete simulation is a set of rules that dictate how clients interact with the store, that is, the connection(s) between these elements.

### C.2 Adapting Social Force Model (SFM)

### C.2.1 Including Customer Vector in SFM Formulation

In an embodiment, customer interaction with products may be modeled by merging the SFM technique with the customer vector. As noted herein, the third term in the summation of social forces (Σₐfᵢₐ(t)) relates how the virtual customer interacts, whether by attraction or repulsion, with store elements such as advertisements and products. In an embodiment, the way this is done is by using as D the measures of interests obtained by market research. Thus, from the 1st up to the ith interests from K are used as D₁ all the way up to Dᵢ.

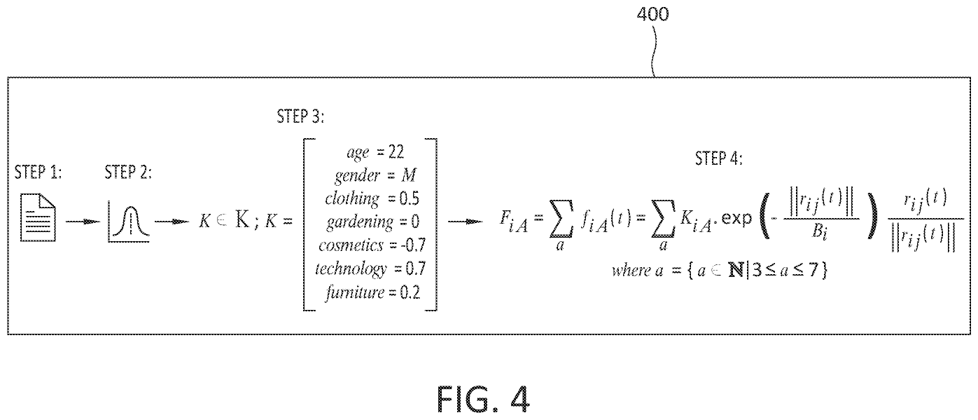

The diagram 400 in FIG. 4 depicts one example of a way to incorporate the market research data from vector K to a simulation technique such as SFM. Notice that negative values represent repulsion. The example of FIG. 4 comprises four steps:
1. market research market research for customer information acquisition;
2. create a probability distribution to sample a possible client—this probability distribution may provide variability to the solution, that is, the optimized layout;
3. sample a customer vector from the distribution K; and
4. use the attributes related to the sampled customer interests a to calculate the forces that will drive the individual i through the store.

### C.2.2 Updating the Simulation

Once the simulation starts, an embodiment may run an ontology for accessing the behavior of the client—in an embodiment, this ontology may be developed by a Subject Matter Expert (SME). In an embodiment, the simulation update step may be based on purchase radius and purchase probability. Thus, the following definitions may be applied:
ρ: radius of purchase ρ, the distance a client is from a product in the store; and
ρ(t): a vector representing the distance the customer is in relation to every product modelled in the simulation.

Whenever the client is inside the purchase radius, that is, close enough to a product such that the product can be picked off a shelf, which may be a predefined distance, a random action takes place, such as picking, or leaving, the product. In this example of ontology, an embodiment may define the action sampling from a binomial distribution that encompasses the characteristics of the customer. Following is a simple example of how this function might be constructed:

P_{purchase}=P(pick|age,gender,interests,income,product)

The aforementioned expression reads as follows: (1) the probability of a customer ID picking a product (2) given the age, gender, interests, income and what the product is within the purchase radius.

Once a product is picked or passed, the customer interest in the product changes to zero in the virtual customer κ, and the customer remains neutral towards that particular product for the rest of the simulation. It is noted here that the format in which the layouts are provided by an embodiment may depend on the method used for crowd motion simulation. Example formats may comprise a CAD (computer aided design) model or even a .csv file containing vertex and labels.

### C.2.3 Apply Optimization Methods for Layout Generation

In an embodiment, the last step is using an optimization algorithm to test and modify several layouts in order to accomplish the goal of obtaining a satisfactorily optimized layout. Several algorithms may be used as a mechanism of iterating through different layouts and optimizing the shelves placement. Also, there exist various metrics that may be used to determine if a layout in particular is optimal, such as, but not limited to, the number of products purchased in a simulation, average time clients spend in store, and distance travelled on each shopper journey.

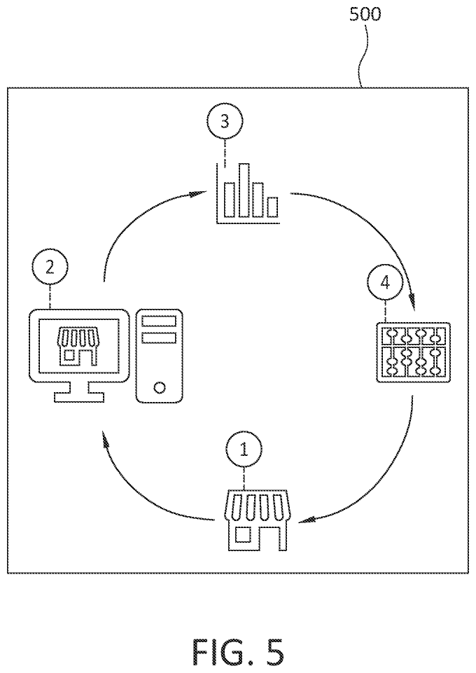

In an embodiment, a choice of layout metric(s) to be optimized may be left to the user who has domain expertise and knowledge of that particular case. That can be multiple metrics can be optimized at the same time, leading to a multiple objective optimization problem. The diagram 500 in FIG. 5 shows a simple high-level scheme of how an embodiment may operate, that is, the diagram 500 comprises an example optimization cycle, one or more of which may be performed in an embodiment. The steps, or operations, depicted in the example of FIG. 5 are:
Step 1: send a virtual store layout to the simulation;
Step 2: run a simulation for the virtual store layout;
Step 3: collect metrics from the simulation; and
Step 4: update store layout with the optimization algorithm.

### C.3 Preventing Degenerate Solutions

There exists a possibility that the optimization algorithm, according to one embodiment, could produce solutions that fit the criteria defined for the objective function but, at the same time, are not representative of real-world situations or desirable layouts. For example, if the objective function is formulated to maximize customer time in store, the optimization algorithm could be creating a layout that allows for customers to get stuck or restrict their mobility in certain areas. Although this layout may optimally solve the problem presented, it is a type of solution that is not desirable, as the algorithm would be only exploiting a loophole. These types of solutions may be referred to as degenerate solutions.

To avoid creation of degenerate solutions, some restrictions may be put in place in an embodiment, such as, adding a property to the vector K which indicates the position of the customer, and if the customer does not move significantly, or moves in circles, the virtual customer can be deleted from the simulation after a threshold number of interactions is reached, and a penalty may be added to the objective function, forcing the degenerate solution to be unfeasible. Other types of degenerate cases may appear by application of an embodiment, especially if used in other domains, such as optimizing layouts for business fairs, airports, shopping malls. However, it is up to a SME to determine what the criteria are to consider a solution to be degenerate, and how the objective function can be adapted to disregard the degenerate solution(s).

### D. Example Case

Following is a theoretical example of how an embodiment be used in the context of store layout optimization. For this case, the problem involves a fictional department store with 4 sectors, namely, electronics (ω₁), furniture (ω₂), hardware (ω₃), and home appliances (ω₄). The objective in this example case is to generate a store layout that efficiently makes clients move through the store and make fast purchases, due to store limited physical space.

### D.1 Setting Up the Optimization Problem

For this problem the virtual client vector may be constructed with the following properties: κᵢ=[a,g,ω₁,ω₂,ω₃,ω₄,t,E]. Here, the ω quantities are the client interest in various store products, the t is the time spent inside the store, E is the propensity of the client to leave the store if t is too large, a is the age of the client, and g is the gender of the client. In an embodiment, an example for the E function is a sigmoidal displaced by t:

$$E = \frac{1}{1 + exp ( - t + {t}_{purchase} )}$$

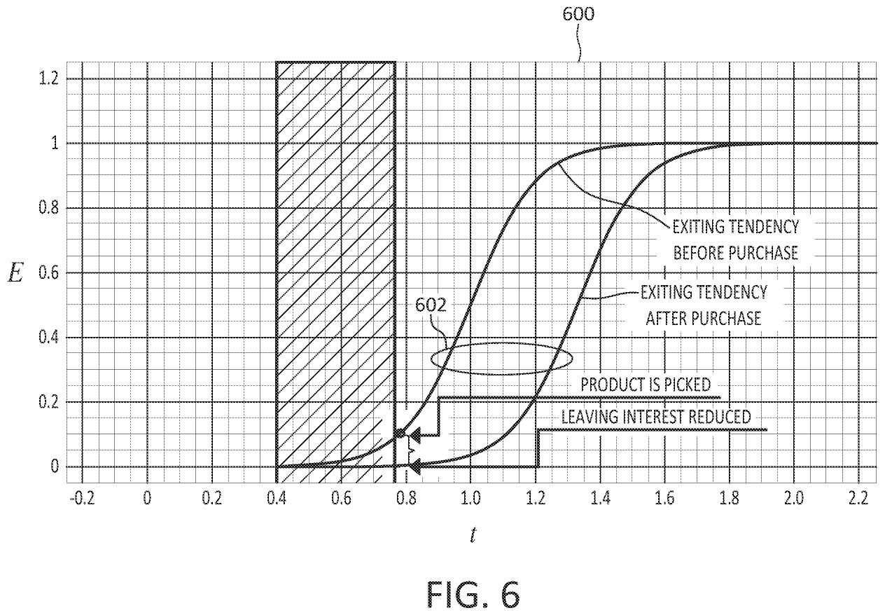

That is, an embodiment may add t_{purchase} to the exponential term of the function whenever a product of interest is picked, thus reducing the customer intention to leave. FIG. 6 shows how this example function behaves.

In particular, the graph 600 in FIG. 6 discloses the behavior of exponential function 602 displaced by t. Now that all the necessary parts for the optimization are in place, the only remaining operation is choosing an optimization algorithm for finding the layout (Δ) that minimizes the specified objective function

$$ℒ ( K ) = \frac{1}{M} {\sum }_{i}^{M} {t}_{i}$$

which represents the average time spent by every customer κ in the store.

$${Λ}^{*} = arg min ( ℒ ( K ) )$$

### D.2 Building the Simulation Domain

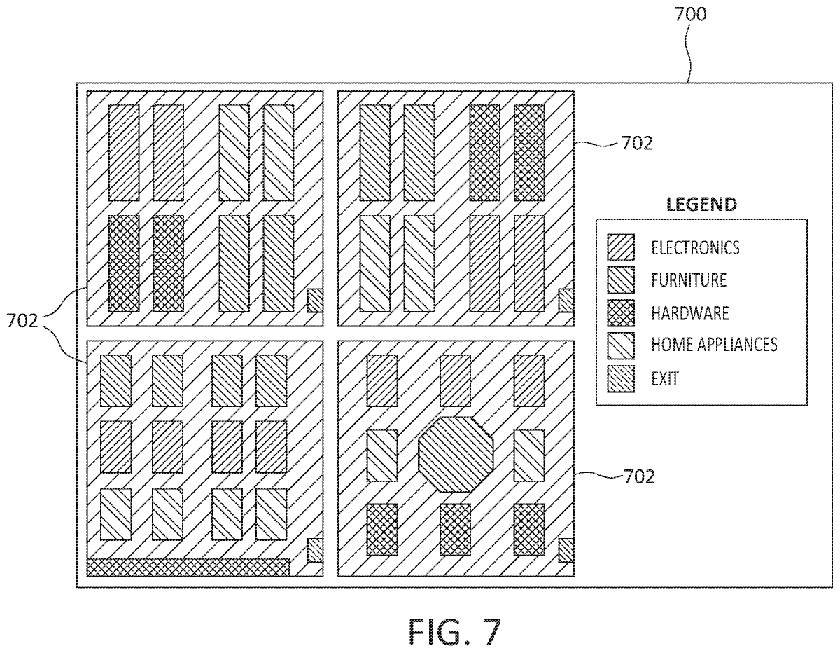

This example case will simulate the use of a search-based algorithm, for example, a genetic algorithm. This type of algorithm requires an initial guess of multiple solutions—for this example problem, FIG. 7 discloses a set 700 of different possible solutions 702, each of which is in the form of an alternative store layout. This set 700 of initial layouts Λ₀ 702 is an example of how to initialize the optimization algorithms in the case of search-based methods.

### D.3 Running the Layout Optimization Pipeline

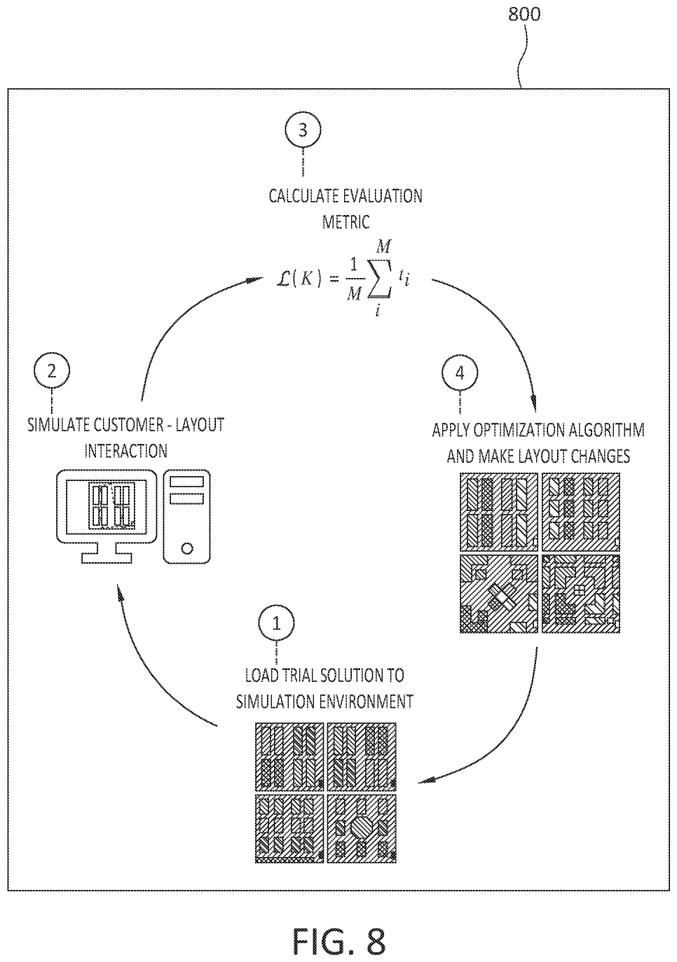

At this point, an embodiment may begin the optimization of the store layouts given the initial guesses, an embodiment may apply the sequence shown earlier in FIG. 5, but shown now in a detailed version in the method 800 of FIG. 8, with the optimization cycle applied. As shown there, the method 800 may begin with the loading (1) of various trial solutions, that is, store layouts, to the problem simulation environment. Next, the customer interactions with those layouts, referred to as customer-layout interactions, may be simulated (2). The evaluation metric may then be calculated (3). Finally, the optimization algorithm may be applied to make changes to the layout(s) loaded at (1). The customer-layout interactions may be run (2) until the method 800 outputs a result that is a feasible and satisfying solution within the proposed evaluation metrics, that is, a store layout that promotes the closest possible interaction of the customer(s) with the store, and products as envisioned by the store administration.

### E. Example Methods

It is noted with respect to the disclosed methods, including the example methods of FIGS. 5 and 8, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### F. Further Example Embodiments

Following are some further example embodiments of the invention. These are presented only by way of example and are not intended to limit the scope of the invention in any way.

Embodiment 1. A method, comprising: constructing a population space of customers; constructing an objective function of interest concerning the customers and a store; using an optimization algorithm to find, based on the objective function of interest, a store layout that maximizes one or more metrics relating to the customers and products of the store; and generating an optimized layout for the store based on an outcome of the optimization algorithm, and the optimized layout satisfies the objective function of interest and is based on buying preferences of the customers.

Embodiment 2. The method as recited in any preceding embodiment, wherein the population space of customers is defined using historical data.

Embodiment 3. The method as recited in any preceding embodiment, wherein the customers are virtual customers.

Embodiment 4. The method as recited in any preceding embodiment, wherein each of the customers is associated with a respective vector that captures preferences of the customer.

Embodiment 5. The method as recited in any preceding embodiment, wherein each of the customers is associated with a respective vector that captures preferences of the customer, and if the optimized layout is a degenerate solution, modifying the vectors.

Embodiment 6. The method as recited in any preceding embodiment, wherein the buying preferences of one of the customers are changeable over time.

Embodiment 7. The method as recited in any preceding embodiment, wherein each of the customers is associated with a respective vector that captures preferences of the customer, and further comprising modeling interaction of the customers with one or more products by merging a social force model (SFM) with the vectors.

Embodiment 8. The method as recited in any preceding embodiment, wherein the optimization algorithm comprises operations including: sending a virtual store layout to a simulation process; running the simulation process for the virtual store layout; collecting metrics from the running of the simulation process; and updating the virtual store layout.

Embodiment 9. The method as recited in any preceding embodiment, wherein the optimized layout is obtained without introduction of human bias.

Embodiment 10. The method as recited in any preceding embodiment, wherein the metrics comprise any one or more of: time that the customers spend in the store; distance traveled by the customers in the store; and, a number of aisles visited by each of the customers.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

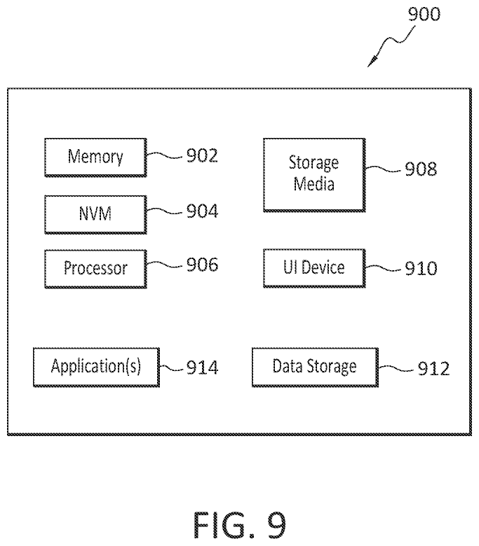

With reference briefly now to FIG. 9, any one or more of the entities disclosed, or implied, by FIGS. 1-8, and/or elsewhere herein, may take the form of, or include, or be implemented on, or hosted by, a physical computing device, one example of which is denoted at 900. As well, where any of the aforementioned elements comprise or consist of a virtual machine (VM), that VM may constitute a virtualization of any combination of the physical components disclosed in FIG. 9.

In the example of FIG. 9, the physical computing device 900 includes a memory 902 which may include one, some, or all, of random access memory (RAM), non-volatile memory (NVM) 904 such as NVRAM for example, read-only memory (ROM), and persistent memory, one or more hardware processors 906, non-transitory storage media 908, UI device 910, and data storage 912. One or more of the memory components 902 of the physical computing device 900 may take the form of solid state device (SSD) storage. As well, one or more applications 914 may be provided that comprise instructions executable by one or more hardware processors 906 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
constructing a population space of customers;
constructing an objective function of interest concerning the customers and a store;
using an optimization algorithm to find, based on the objective function of interest, a store layout that maximizes one or more metrics relating to the customers and products of the store; and
generating an optimized layout for the store based on an outcome of the optimization algorithm, and the optimized layout satisfies the objective function of interest and is based on buying preferences of the customers.

2. The method as recited in claim 1, wherein the population space of customers is defined using historical data.

3. The method as recited in claim 1, wherein the customers are virtual customers.

4. The method as recited in claim 1, wherein each of the customers is associated with a respective vector that captures preferences of the customer.

5. The method as recited in claim 1, wherein each of the customers is associated with a respective vector that captures preferences of the customer, and if the optimized layout is a degenerate solution, modifying the vectors.

6. The method as recited in claim 1, wherein the buying preferences of one of the customers are changeable over time.

7. The method as recited in claim 1, wherein each of the customers is associated with a respective vector that captures preferences of the customer, and further comprising modeling interaction of the customers with one or more products by merging a social force model (SFM) with the vectors.

8. The method as recited in claim 1, wherein the optimization algorithm comprises operations including: sending a virtual store layout to a simulation process; running the simulation process for the virtual store layout; collecting metrics from the running of the simulation process; and updating the virtual store layout.

9. The method as recited in claim 1, wherein the optimized layout is obtained without introduction of human bias.

10. The method as recited in claim 1, wherein the metrics comprise any one or more of: time that the customers spend in the store; distance traveled by the customers in the store; and, a number of aisles visited by each of the customers.

11. A non-transitory storage medium having stored therein instructions that are executable by one or more hardware processors to perform operations comprising:
constructing a population space of customers;
constructing an objective function of interest concerning the customers and a store;
using an optimization algorithm to find, based on the objective function of interest, a store layout that maximizes one or more metrics relating to the customers and products of the store; and
generating an optimized layout for the store based on an outcome of the optimization algorithm, and the optimized layout satisfies the objective function of interest and is based on buying preferences of the customers.

12. The non-transitory storage medium as recited in claim 11, wherein the population space of customers is defined using historical data.

13. The non-transitory storage medium as recited in claim 11, wherein the customers are virtual customers.

14. The non-transitory storage medium as recited in claim 11, wherein each of the customers is associated with a respective vector that captures preferences of the customer.

15. The non-transitory storage medium as recited in claim 11, wherein each of the customers is associated with a respective vector that captures preferences of the customer, and if the optimized layout is a degenerate solution, modifying the vectors.

16. The non-transitory storage medium as recited in claim 11, wherein the buying preferences of one of the customers are changeable over time.

17. The non-transitory storage medium as recited in claim 11, wherein each of the customers is associated with a respective vector that captures preferences of the customer, and further comprising modeling interaction of the customers with one or more products by merging a social force model (SFM) with the vectors.

18. The non-transitory storage medium as recited in claim 11, wherein the optimization algorithm comprises operations including: sending a virtual store layout to a simulation process; running the simulation process for the virtual store layout; collecting metrics from the running of the simulation process; and updating the virtual store layout.

19. The non-transitory storage medium as recited in claim 11, wherein the optimized layout is obtained without introduction of human bias.

20. The non-transitory storage medium as recited in claim 11, wherein the metrics comprise any one or more of: time that the customers spend in the store; distance traveled by the customers in the store; and, a number of aisles visited by each of the customers.
